(19) United States
(12) Patent Application Publication
(10) Pub. No.: US 2020/0014062 A1
(43) Pub. Date: Jan. 9, 2020

(54) Battery Cell Sheet, Secondary Battery, Method of Manufacturing Battery Cell Sheet, and Method of Manufacturing Secondary Battery

(71) Applicant: Hitachi, Ltd., Tokyo (JP)

(72) Inventors: Yusuke KAGA, Tokyo (JP); Motoyuki HIROOKA, Tokyo (JP); Etsuko NISHIMURA, Tokyo (JP); Eiji SEKI, Tokyo (JP); Shimpei AMASAKI, Tokyo (JP)

(21) Appl. No.: 16/454,381

(22) Filed: Jun. 27, 2019

(30) Foreign Application Priority Data
Jul. 5, 2018 (JP) 2018-128242

(51) Int. Cl. H01M 10/0562; H01M 4/139; H01M 4/66; H01M 4/36; H01M 4/04

(52) U.S. Cl. CPC H01M 10/0562; H01M 4/139; H01M 4/70; H01M 4/366; H01M 4/0404; H01M 4/669

(57) ABSTRACT

Provided is a battery cell sheet and a secondary battery that can prevent a variation in an electrolyte composition due to volatilization and do not cause a decrease in battery performance even in a case where a component with high volatility is used. The battery cell sheet includes: an electrode that includes an electrode current collector, and electrode mixture layers respectively formed on both upper and lower surfaces of the electrode current collector; a first semi-solid electrolyte layer and a second semi-solid electrolyte layer that are respectively laminated on upper and lower surfaces of the electrode; a first sealing sheet and a second sealing sheet that respectively adhere to and cover a surface of each semi-solid electrolyte layer opposite to a surface thereof laminated with the electrode, and seal the electrode with both of the first semi-solid electrolyte layer and the second semi-solid electrolyte layer; a non-aqueous solution that is provided between each of the electrode mixture layers of the electrode and each semi-solid electrolyte layer; and a sealing portion that is provided at an end side portion of each of the first sealing sheet and the second sealing sheet.

### TECHNICAL FIELD

The present invention relates to a battery cell sheet, a secondary battery, a method of manufacturing the battery cell sheet, and a method of manufacturing the secondary battery.

### BACKGROUND ART

An electrolyte used for a secondary battery represented by a lithium ion secondary battery is a medium that includes an ion (for example, a lithium ion) according to a purpose, and has a function of transporting the ion between a positive electrode and a negative electrode to enable charging and discharging by exchanging charges.

In recent years, in order to overcome drawbacks such as liquid leakage or evaporation of an electrolyte solution contained in the secondary battery, a sheet-type secondary battery using a polymer electrolyte (a solid electrolyte), and an electrolyte, which is obtained by mixing inorganic microparticles with an ionic liquid and thickening or gelling the liquid, have been proposed.

WO 2007/086518 (PTL 1) is used as a background art in the present technical field. PTL 1 describes an electrolyte composition for a secondary battery, an electrolyte film formed of the composition, and a secondary battery containing the electrolyte film. The electrolyte composition provides a molded body having high ionic conductivity and a high ionic transportation ratio (a ratio of a current carried by a specific ion to total currents when the currents flow in an electrolyte solution).

### CITATION LIST

### Patent Literature

PTL 1: WO 2007/086518

### SUMMARY OF INVENTION

### Technical Problem

In recent years, a semi-solid electrolyte has attracted attention as an electrolyte for the secondary battery. The semi-solid electrolyte has a structure in which an electrolytic solution is supported on a skeleton material of an insulation solid, with a large specific surface area, such as a microparticle, and does not have fluidity. A secondary battery is formed by providing the semi-solid electrolyte formed into a sheet shape (hereinafter, referred to as a semi-solid electrolyte sheet) between a positive electrode and a negative electrode.

In order to improve ionic conductivity, a low viscosity solvent, such as propylene carbonate or ethylene carbonate, may be added to the semi-solid electrolyte sheet. In addition, a negative electrode interface stabilizer such as vinylene carbonate or fluoroethylene carbonate may be added in order to prevent a reductive decomposition reaction of the electrolyte on a negative electrode surface. However, the above compound has high volatility, and thus the electrolyte composition may change due to volatilization under a dry atmosphere that is a battery manufacturing environment, causing a decrease in battery performance.

In addition, there is a method in which an electrode laminated body is formed by alternately laminating a positive electrode with a negative electrode via a semi-solid electrolyte sheet, the electrode laminated body is inserted into an outer package body, a component with high volatility is then added by liquid injection, and the outer package body is closed. However, introduction of the liquid injection step causes an increase in lead time and a decrease in productivity.

PTL 1 describes the electrolyte film in which an organic compound such as propylene carbonate or ethylene carbonate is added to increase the ionic conductivity. However, PTL 1 does not describe a method of constructing and manufacturing the electrolyte film considering the component with high volatility, which is an object of the invention. Accordingly, the electrolyte composition may change due to volatilization, which may cause a decrease in battery performance.

Therefore, an object of the invention is to provide a battery cell sheet and a secondary battery that can prevent a variation in an electrolyte composition due to volatilization and do not cause a decrease in battery performance even in a case where a component with high volatility is used.

### Solution to Problem

In a preferred embodiment of the invention, there is provided a battery cell sheet including: an electrode that includes an electrode current collector, and electrode mixture layers respectively formed on both upper and lower surfaces of the electrode current collector; a first semi-solid electrolyte layer and a second semi-solid electrolyte layer that are respectively laminated on upper and lower surfaces of the electrode; a first sealing sheet and a second sealing sheet that respectively adhere to and cover a surface of each semi-solid electrolyte layer opposite to a surface thereof laminated with the electrode, and seal the electrode with the first semi-solid electrolyte layer and the second semi-solid electrolyte layer; a non-aqueous solution that is provided between each of the electrode mixture layers of the electrode and each semi-solid electrolyte layer; and a sealing portion that is provided at an end side portion of each of the first sealing sheet and the second sealing sheet.

In addition, in a preferred embodiment of the invention, there is provided a method of manufacturing a battery cell sheet. The method includes: a step of forming an electrode by applying electrode mixture layers onto respective upper and lower surfaces of an electrode current collector; a step of adding a non-aqueous solution to surfaces of electrode mixture layers of the electrode; a step of transferring, by roller winding, a semi-solid electrolyte sheet including a semi-solid electrolyte layer and a sealing sheet, and adding the non-aqueous solution to the semi-solid electrolyte layer; a step of laminating the electrode to a first semi-solid electrolyte sheet and a second semi-solid electrolyte sheet, such that a first electrode mixture layer on an upper surface side of the electrode faces the semi-solid electrolyte layer of the first semi-solid electrolyte sheet supplied to the upper surface side of the electrode, and a second electrode mixture layer on a lower surface side of the electrode faces the semi-solid electrolyte layer of the second semi-solid electrolyte sheet supplied to the lower surface side of the electrode; a step of cutting the first semi-solid electrolyte sheet and the second semi-solid electrolyte sheet; and a step of forming a sealing portion by heating and pressurizing, with a heat seal unit, an end side portion of a laminated body obtained by laminating the electrode to the first semi-solid electrolyte sheet and the second semi-solid electrolyte sheet.

In addition, in a preferred embodiment of the invention, there is provided a secondary battery. The secondary battery includes a battery cell sheet including an electrode that includes an electrode current collector of first polarity, and electrode mixture layers respectively formed on both upper and lower surfaces of the electrode current collector of first polarity, a first semi-solid electrolyte layer and a second semi-solid electrolyte layer that are respectively laminated on upper and lower surfaces of the electrode, a first sealing sheet and a second sealing sheet that respectively adhere to and cover a surface of each semi-solid electrolyte layer opposite to a surface thereof laminated with the electrode, and seal the electrode with the first semi-solid electrolyte layer and the second semi-solid electrolyte layer, a non-aqueous solution that is provided between each of the electrode mixture layers of the electrode and each semi-solid electrolyte layer, and a sealing portion that is provided at an end side portion of each of the first sealing sheet and the second sealing sheet, in which the battery cell sheet is placed with a sealing sheet on at least an upper laminated surface side peeling off, an electrode is laminated over the battery cell sheet, the electrode including an electrode current collector of second polarity different from the first polarity, and electrode mixture layers respectively formed on both upper and lower surfaces of the electrode current collector of second polarity, the battery cell sheet is laminated over the electrode of second polarity with a first sealing sheet and a second sealing sheet peeling off, lamination of the electrode of second polarity and the battery cell sheet, in which the first sealing sheet and the second sealing sheet are peeled off, is repeated, a sealing sheet on at least a lower laminated surface side in an uppermost battery cell sheet is peeled off, tab portions of electrode current collectors of first polarity in the laminated battery cell sheets are welded, tab portions of electrode current collectors of second polarity in the laminated electrodes of second polarity are welded, and the laminated battery cell sheets and electrodes of second polarity are stored in an outer package body with tab portions of the first polarity and tab portions of the second polarity protruding out of the outer package body.

### Advantageous Effect of Invention

According to the invention, it is possible to provide a battery cell sheet and a secondary battery that do not cause a decrease in battery performance even in a case where a component with high volatility is used.

### BRIEF DESCRIPTION OF DRAWINGS

FIG. 1 is a diagram schematically showing a method of manufacturing a battery cell sheet.

FIG. 2A is a plan view schematically showing a battery cell sheet according to a first embodiment.

FIG. 2B is a cross-sectional view of the battery cell sheet taken along a line A-A′ shown in FIG. 2A.

FIG. 2C is a cross-sectional view of the battery cell sheet taken along a line B-B′ shown in FIG. 2A.

FIG. 2D is a cross-sectional view of the battery cell sheet taken along a line C-C′ shown in FIG. 2A.

FIG. 3A is a plan view schematically showing a battery cell sheet according to a second embodiment.

FIG. 3B is a cross-sectional view of the battery cell sheet taken along a line A-A′ shown in FIG. 3A.

FIG. 3C is a cross-sectional view of the battery cell sheet taken along a line B-B′ shown in FIG. 3A.

FIG. 4A is a plan view schematically showing a battery cell sheet according to a third embodiment.

FIG. 4B is a cross-sectional view of the battery cell sheet taken along a line A-A′ shown in FIG. 4A.

FIG. 4C is a cross-sectional view of the battery cell sheet taken along a line B-B′ shown in FIG. 4A.

FIG. 5 is a diagram schematically showing a method of manufacturing an electrode laminated body.

FIG. 6A is a plan view schematically showing an electrode laminated body according to a fourth embodiment.

FIG. 6B is a cross-sectional view of the electrode laminated body taken along a line A-A′ shown in FIG. 6A.

FIG. 6C is a cross-sectional view of the electrode laminated body taken along a line B-B′ shown in FIG. 6A.

FIG. 6D is a cross-sectional view of the electrode laminated body taken along a line C-C′ shown in FIG. 6A.

FIG. 7 is a plan view schematically showing a laminated secondary battery.

FIG. 8A is a plan view schematically showing an electrode laminated body according to a fifth embodiment.

FIG. 8B is a cross-sectional view of the electrode laminated body taken along a line A-A′ shown in FIG. 8A.

FIG. 8C is a cross-sectional view of the electrode laminated body taken along a line B-B′ shown in FIG. 8A.

FIG. 8D is a cross-sectional view of the electrode laminated body taken along a line C-C′ shown in FIG. 8A.

FIG. 9A is a plan view schematically showing an electrode laminated body according to a sixth embodiment.

FIG. 9B is a cross-sectional view of the electrode laminated body taken along a line A-A′ shown in FIG. 9A.

FIG. 9C is a cross-sectional view of the electrode laminated body taken along a line B-B′ shown in FIG. 9A.

FIG. 9D is a cross-sectional view of the electrode laminated body taken along a line C-C′ shown in FIG. 9A.

FIG. 10 is a diagram showing an evaluation result of a full-cell in a liquid injection process.

FIG. 11 is a diagram showing results of the weight percentage of propylene carbonate in a model cell and initial capacity in evaluation experiments of a positive electrode half-cell in processes of the first to sixth embodiments.

FIG. 12 is a diagram showing results of the weight percentage of propylene carbonate in a model cell and initial capacity in evaluation experiments of a negative half-cell in the processes of the first to sixth embodiments.

FIG. 13 is a diagram showing results of the weight percentage of vinylene carbonate in a model cell and initial capacity in evaluation experiments of a negative half-cell in the processes of the first to sixth embodiment.

### DESCRIPTION OF EMBODIMENTS

Hereinafter, embodiments of the invention will be described in detail with reference to the drawings. In all the drawings for showing the embodiments, the members having the same function are denoted by the same reference numerals, and repetitive descriptions thereof are omitted. In addition, in the embodiments, the description of the same or similar portions will not be repeated in principle unless necessary. Further, in the drawings showing the embodiments, hatching may be omitted even in a cross-sectional view, in order to make the configuration easy to understand.

### Example 1

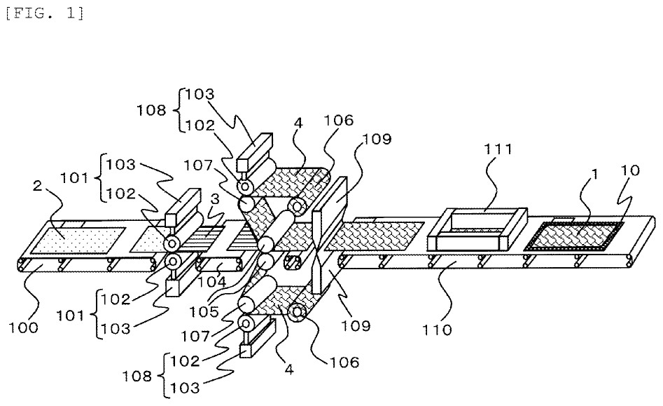

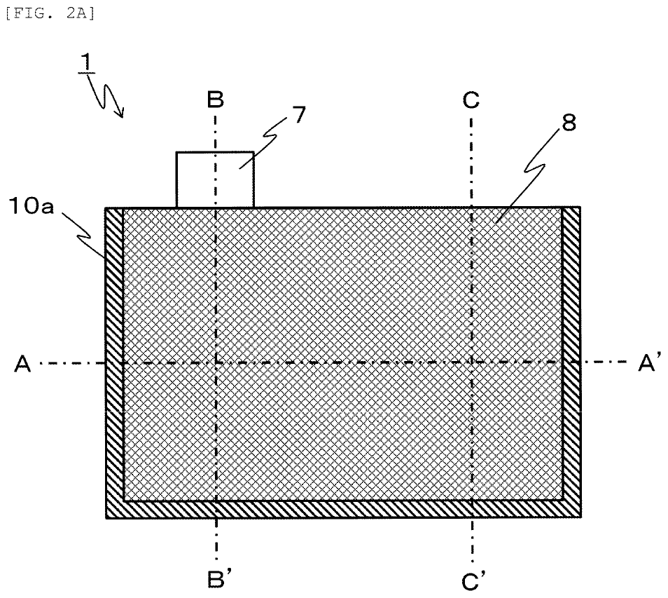

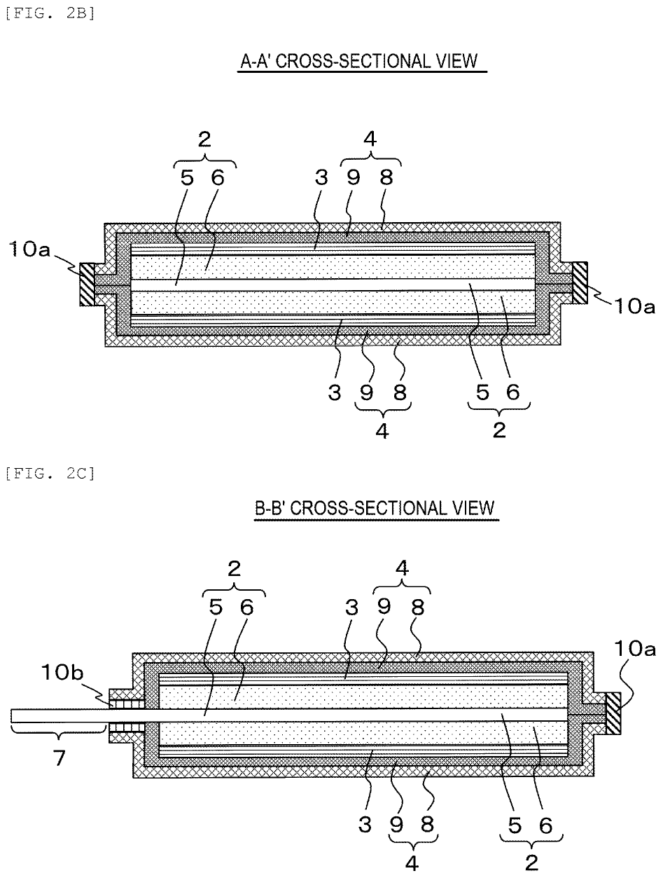

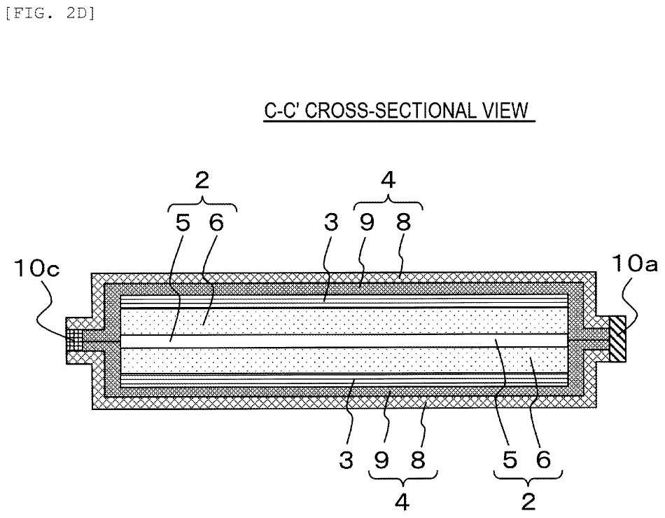

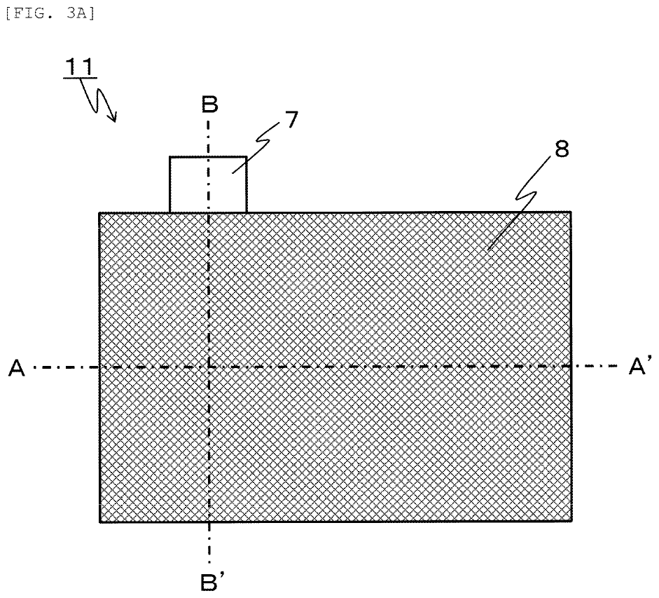

The present embodiment will be described with reference to FIG. 1 and FIGS. 2A to 2D, taking a battery cell sheet that is a component of a laminated secondary battery as an example.

FIG. 1 is a schematic view of a method of manufacturing a battery cell sheet 1. An introduced electrode 2 is transferred to a position on a coating unit 101 by a transfer unit 100. In the coating unit 101, a non-aqueous solution 3 is supplied from a liquid tank 103 to rollers 102. The roller 102 may be formed of a material corrosion-resistant to the non-aqueous solution 3, including but are not limited to a polypropylene resin, a polyethylene resin, a polyurethane resin, a chloroprene resin, a silicone resin, and a fluorine resin. The non-aqueous solution 3 is added to both surfaces of the electrode 2 by passing the electrode 2 between the rollers 102.

Next, the electrode 2 is transferred to a position on a lamination roller 105 by a transfer unit 104. In the lamination roller 105, a semi-solid electrolyte sheet 4 is laminated on both surfaces of the electrode 2. The semi-solid electrolyte sheet 4 is supplied from a semi-solid electrolyte roller 106 and is transferred to a position on a coating unit 108 facing a guide roller 107. In the coating unit 108, the non-aqueous solution 3 is coated onto a surface of the semi-solid electrolyte sheet 4 on which a semi-solid electrolyte layer 9 to be described below is formed. Thereafter, the semi-solid electrolyte sheet 4 is supplied to the lamination roller 105 via the guide roller 107.

The electrode 2 is laminated with the semi-solid electrolyte sheet 4 by the lamination roller 105, and then the semi-solid electrolyte sheet 4 is cut by a cutting unit 109. Then, the semi-solid electrolyte sheet 4 is transferred to a position on a heat seal unit 111 by a transfer unit 110. In the heat seal unit 111, an end side portion of the semi-solid electrolyte sheet 4 is welded to obtain the battery cell sheet 1 including a sealing portion 10.

FIG. 2A is a plan view schematically showing the battery cell sheet 1. FIG. 2B is a cross-sectional view taken along a cutting line A-A′ in FIG. 2A, FIG. 2C is a cross-sectional view taken along a cutting line B-B′ in FIG. 2A, and FIG. 2D is a cross-sectional view taken along a cutting line C-C′ in FIG. 2A.

As shown in FIGS. 2A to 2D, the battery cell sheet 1 includes the electrode 2, the non-aqueous solution 3, and the semi-solid electrolyte sheet 4. In the electrode 2, electrode mixture layers 6 are respectively formed on both surfaces of a current collector 5. In addition, the electrode 2 includes a tab portion 7 on which no electrode mixture layer is formed. In the semi-solid electrolyte sheet 4, the semi-solid electrolyte layer 9 is formed on one side of each of sealing sheets 8. The semi-solid electrolyte layer 9 is formed of an electrolytic solution, supporting materials of the electrolytic solution, and a binder, which will be described below. The non-aqueous solution 3 is provided between each of the electrode mixture layers 6 and each semi-solid electrolyte layer 9.

The semi-solid electrolyte layer 9 of the semi-solid electrolyte sheet 4 and the electrode mixture layer 6 of the electrode 2 are laminated so as to face each other, and a sealing portion 10a, a sealing portion 10b, and a sealing portion 10c are formed so as to surround the electrode 2.

As shown in FIG. 2B, the sealing portion 10a is integrally formed by welding the facing sealing sheets 8 with the heat seal unit 111.

In addition, as shown in FIG. 2C, in the sealing portion 10b, the semi-solid electrolyte layer 9 and the tab portion 7 are heated and pressurized by the heat seal unit 111, so that the supporting materials of the semi-solid electrolyte layer 9 become dense, the binder is melted, and a gap between the supporting materials is blocked. Further, the binder is melted to adhere to the tab portion 7, so that the sealing portion 10b is formed.

Further, as shown in FIG. 2D, the facing semi-solid electrolyte layers 9 are heated and pressurized by the heat seal unit 111, so that the supporting materials of the semi-solid electrolyte layer 9 become dense, the binder is melted, and a gap between the supporting materials is blocked. Accordingly, the sealing portion 10c is formed, and the facing semi-solid electrolyte layers 9 are integrated.

The non-aqueous solution 3 is sealed in the battery cell sheet 1 by the sealing portion 10a, the sealing portion 10b, and the sealing portion 10c. Here, the electrode 2 may be a positive electrode 2a or a negative electrode 2b.

Next, constituent materials and manufacturing methods will be described.

First, a constituent material of the non-aqueous solution 3 will be described.

A low viscosity solvent or a negative electrode interface stabilizer can be used as the non-aqueous solution 3. Specific examples of the low-viscosity solvent include, but are not limited to, propylene carbonate, trimethyl phosphate, gamma butyl lactone, ethylene carbonate, triethyl phosphate, tris(2,2,2-trifluoroethyl) phosphite, and dimethyl methylphosphonate. Specific examples of the negative electrode interface stabilizer include, but are not limited to, vinylene carbonate, and fluoroethylene carbonate. These low viscosity solvents or negative electrode interface stabilizers may be used alone or in combination.

The non-aqueous solution 3 may contain a non-aqueous solvent. The non-aqueous solvent is not particularly limited, and examples thereof include an organic solvent, an ionic liquid, and a substance showing a property similar to that of an ionic liquid in the presence of electrolyte salts (in the present description, the substance showing the property similar to that of the ionic liquid in the presence of the electrolyte salts is collectively referred to as an “ionic liquid”). Specific examples of the non-aqueous solvent include tetraethylene glycol dimethyl ether, triethylene glycol dimethyl ether, 1-ethyl-3-methylimidazolium bis(trifluoromethanesulfonyl) imide, 1-ethyl-3-methylimidazolium trifluoromethanesulfonate, 1-butyl-1-methylpyrrolidinium bis (trifluoromethanesulfonyl) imide, ethylene carbonate, dimethyl carbonate, ethyl methyl carbonate, propylene carbonate, diethyl carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methyl sulfolane, acetonitrile, propionitrile, and a mixed liquid thereof.

In addition, an electrolyte salt may be dissolved in the non-aqueous solution 3. Specific examples of the electrolyte salt include a lithium salt such as (CF₃SO₂)₂NLi, (SO₂F)₂NLi, LiPF₆, LiClO₄, LiAsF₆, LiBF₄, LiB(C₆H₅)₄, CH₃SO₃Li, CF₃SO₃Li, and a mixture thereof.

Further, the non-aqueous solution 3 may contain a corrosion inhibitor. The corrosion inhibitor is represented by (M-R)⁺An⁻, in which a cation of (M-R)⁺An⁻ is (M-R)⁺, M is any one of nitrogen (N), boron (B), phosphorus (P), and sulfur (S), and R is a hydrocarbon group. In addition, an anion of (M-R)⁺An⁻ is An⁻, and BF₄⁻ or PF₆⁻ is preferably used. Examples of the corrosion inhibitor include a quaternary ammonium salt such as tetrabutylammonium hexafluorophosphate (NBu₄PF₆) and tetrabutylammonium tetrafluoroborate (NBu₄BF₄), an imidazolium salt such as 1-ethyl-3-methylimidazolium tetrafluoroborate (EMI-BF₄) 1-ethyl-3-methylimidazolium hexafluorophosphate (EMI-PF₆), 1-butyl-3-methylimidazolium tetrafluoroborate (BMI-BF₄), and 1-butyl-3-methylimidazolium hexafluorophosphate (BMI-PF₆).

Next, a constituent material and a manufacturing method of the semi-solid electrolyte sheet 4 will be described.

The semi-solid electrolyte sheet contains an electrolytic solution, supporting materials of the electrolytic solution, and a binder that binds together the supporting materials. The electrolytic solution is not particularly limited as long as it is a non-aqueous electrolytic solution. Specifically, a Li salt such as (CF₃SO₂)₂NLi, (SO₂F)₂NLi, LiPF₆, LiClO₄, LiAsF₆, LiBF₄, LiB(C₆H₅)₄, CH₃SO₃Li, CF₃SO₃Li and a mixture thereof can be used as an example of the electrolyte salt. In addition, a solvent of the non-aqueous electrolytic solution may be an organic solvent, an ionic liquid, or a substance showing a property similar to that of an ionic liquid in the presence of electrolyte salts (in the present patent, the substance showing the property similar to that of the ionic liquid in the presence of the electrolyte salts may also be simply referred to as an ionic liquid). As an example of the solvent of the non-aqueous electrolytic solution, tetraethylene glycol dimethyl ether, triethylene glycol dimethyl ether, 1-ethyl-3-methylimidazolium bis (trifluoromethanesulfonyl) imide, 1-ethyl-3-methylimidazolium trifluoromethanesulfonate, 1-butyl-1-methylpyrrolidinium bis (trifluoromethanesulfonyl) imide, ethylene carbonate, dimethyl carbonate, ethyl methyl carbonate, propylene carbonate, diethyl carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methyl sulfolane, acetonitrile, propionitrile, and a mixed liquid thereof can be used.

Particles are used as the supporting materials of the electrolytic solution. In order to increase the supporting amount of the electrolytic solution, a surface area per unit volume may be sufficiently large. Accordingly, microparticles are desired. A material for the microparticles include, but are not limited to, silicon dioxide, aluminum oxide, titanium dioxide, zirconium oxide, polypropylene, polyethylene, and a mixture thereof.

The binder is not particularly limited as long as it is a material capable of binding the supporting materials. Polyvinyl fluoride, polyvinylidene fluoride (PVDF), polytetrafluoroethylene, a copolymer of vinylidene fluoride and hexafluoropropylene (P(VDF-HFP)), polyimide, a styrene butadiene rubber, and a mixture thereof can be used.

A semi-solid electrolyte slurry is prepared by mixing the electrolytic solution, the supporting materials, and the binder, and further dispersing the mixture in a dispersion solvent, for example, n-methyl-2-pyrrolidone (NMP). The above semi-solid electrolyte slurry is coated onto the sealing sheet 8. A sheet, which is non-porous and is not permeated by the electrolytic solution or the dispersion solvent, is used as the sealing sheet 8. For example, a resin film such as polyethylene terephthalate, polyethylene, polypropylene and polyimide, or a film obtained by laminating a resin film to a metal foil such as stainless steel, aluminum and copper may be used. Next, the semi-solid electrolyte slurry is dried by a drying furnace. Specifically, for example, the sealing sheet 8 coated with the semi-solid electrolyte slurry is heated at 120° C. or lower, to dry the semi-solid electrolyte slurry coated onto the sealing sheet 8. Here, the heating treatment is required to be set at a temperature at which the electrolytic solution does not decompose. Accordingly, the semi-solid electrolyte sheet 4 in which the semi-solid electrolyte layer 9 is formed on the sealing sheet 8 can be obtained.

Next, a constituent material and a manufacturing method of the positive electrode 2a will be described.

The positive electrode 2a includes a positive electrode current collector 5a, a positive electrode mixture layer 6a coated onto the positive electrode current collector 5a, and a positive electrode tab portion 7a. Examples of the positive electrode current collector 5a include a metal foil such as a stainless steel foil and an aluminum foil. A thickness of the positive electrode current collector 5a is, for example, 5 μm to 20 μm.

The positive electrode mixture layer 6a is formed by applying a positive electrode mixture formed of a positive electrode active material, a binder, a conductive assistant, and a semi-solid electrolyte onto the positive electrode current collector 5a.

Examples of the positive electrode active material include, but are not limited to, lithium cobaltate, lithium nickelate, and lithium manganate. Specifically, the positive electrode active material may be a material into/from which lithium can be inserted/released in a crystal structure, and may be a lithium-containing transition metal oxide into which a sufficient amount of lithium is inserted in advance. The transition metal may be a simple substance such as manganese (Mn), nickel (Ni), cobalt (Co) and iron (Fe), or may be a material including two or more kinds of transition metals as main components. In addition, a crystal structure such as a spinel crystal structure or a layered crystal structure is not particularly limited as long as the crystal structure is a structure into/from which lithium ions can be inserted/released. Further, the positive electrode active material may be a material obtained by substituting a part of the transition metal and lithium in crystals with an element such as Fe, Co, Ni, Cr, Al and Mg, or a material obtained by doping an element such as Fe, Co, Ni, Cr, Al and Mg into a crystal.

For example, polyvinyl fluoride, polyvinylidene fluoride, polytetrafluoroethylene, and a polyvinylidene fluoride-hexafluoropropylene copolymer can be used as the binder.

A carbon material such as acetylene black, ketjen black, artificial graphite and carbon nanotubes can be used as the conductive assistant.

A material similar to those used in the case of the semi-solid electrolyte sheet 4 can be used as the semi-solid electrolyte. The particles used as the supporting materials may be the conductive assistant. It is preferable that a necessary amount of the semi-solid electrolyte is mixed with the positive electrode mixture layer 6a in advance. Alternatively, in reducing the amount of the semi-solid electrolyte to be mixed in advance (the semi-solid electrolyte may not be mixed), the semi-solid electrolyte may be added with an electrolyte salt dissolved in the non-aqueous solution 3 in a step of adding the non-aqueous solution 3 to both surfaces of the electrode 2 by the coating unit 101 shown in FIG. 1.

A positive electrode slurry is prepared by mixing the positive electrode active material, the conductive assistant, the binder, and the semi-solid electrolyte, and further dispersing the mixture in a dispersion solvent, for example, N-methyl-2-pyrrolidone (NMP). The positive electrode slurry is coated onto the positive electrode current collector 5a and is dried in a drying furnace. Specifically, for example, the positive electrode current collector 5a coated with the positive electrode slurry is heated at 120° C. or lower, to dry the positive electrode slurry coated onto the positive electrode current collector 5a. Then, the dried film is compressed with pressing to obtain the positive electrode mixture layer 6a. A thickness of the positive electrode mixture layer 6a is, for example, 10 μm to 200 μm depending on capacity. Next, the positive electrode current collector 5a coated with the positive electrode mixture layer 6a is punched to have a predetermined size and shape, so as to obtain the positive electrode 2a.

Next, a material and a manufacturing method of the negative electrode 2b will be described.

The negative electrode 2b includes a negative electrode current collector 5b and a negative electrode mixture layer 6b coated onto the negative electrode current collector 5b. Examples of the negative electrode current collector 5b include a metal foil such as a stainless steel foil and a copper foil. A thickness of the negative electrode current collector 5b is, for example, 5 μm to 20 μm.

The negative electrode mixture layer 6b is formed by applying a negative electrode mixture formed of a negative electrode active material, a binder, a conductive assistant, and a semi-solid electrolyte onto the negative electrode current collector 5b.

For example, a crystalline carbon material or an amorphous carbon material can be used as the negative electrode active material. However, the negative electrode active material is not limited to these substances, and a carbon material such as natural graphite, various artificial graphite agents and coke may be used. Further, various particle shapes such as a scaly shape, a spherical shape, a fibrous shape and a block shape can be coated onto the shape of particles in the negative electrode active material.

For example, polyvinyl fluoride, polyvinylidene fluoride, polytetrafluoroethylene, and a polyvinylidene fluoride-hexafluoropropylene copolymer can be used as the binder.

A carbon material such as acetylene black, ketjen black, artificial graphite and carbon nanotubes can be used as the conductive assistant.

A material similar to those used in the case of the positive electrode 2a can be used as the semi-solid electrolyte. It is preferable that a necessary amount of the semi-solid electrolyte is mixed with the negative electrode mixture layer 6b in advance. Alternatively, in reducing the amount of the semi-solid electrolyte to be mixed in advance (the semi-solid electrolyte may not be mixed), the semi-solid electrolyte may be added with an electrolyte salt dissolved in the non-aqueous solution 3 in the step of adding the non-aqueous solution 3 to both surfaces of the electrode 2 by the coating unit 101 shown in FIG. 1.

A negative electrode slurry is prepared by mixing a negative electrode active material, a conductive assistant, a binder, and a semi-solid electrolyte, and further dispersing the mixture in a dispersion solvent, for example, N-methyl-2-pyrrolidone (NMP). The negative electrode slurry is coated onto the negative electrode current collector 5b and is dried in a drying furnace. Specifically, for example, the negative electrode current collector 5b coated with the negative electrode slurry heated at 120° C. or lower, to dry the negative electrode slurry coated onto the negative electrode current collector 5b. Then, the dried film is compressed with pressing to obtain the negative electrode mixture layer 6b. A thickness of the negative electrode mixture layer 6b is, for example, 10 μm to 200 μm depending on capacity. Next, the negative electrode current collector 5b coated with the negative electrode mixture layer 6b is punched to have a predetermined size and shape, so as to obtain the negative electrode 2b.

According to the present embodiment, the non-aqueous solution 3 is sealed in the battery cell sheet by the sealing portion 10a, the sealing portion 10b, and the sealing portion 10c, so that volatilization of an electrolyte component can be prevented even under a dry atmosphere that is a battery manufacturing environment. Therefore, a variation in an electrolyte composition and a decrease in battery performance can be prevented.

### Example 2

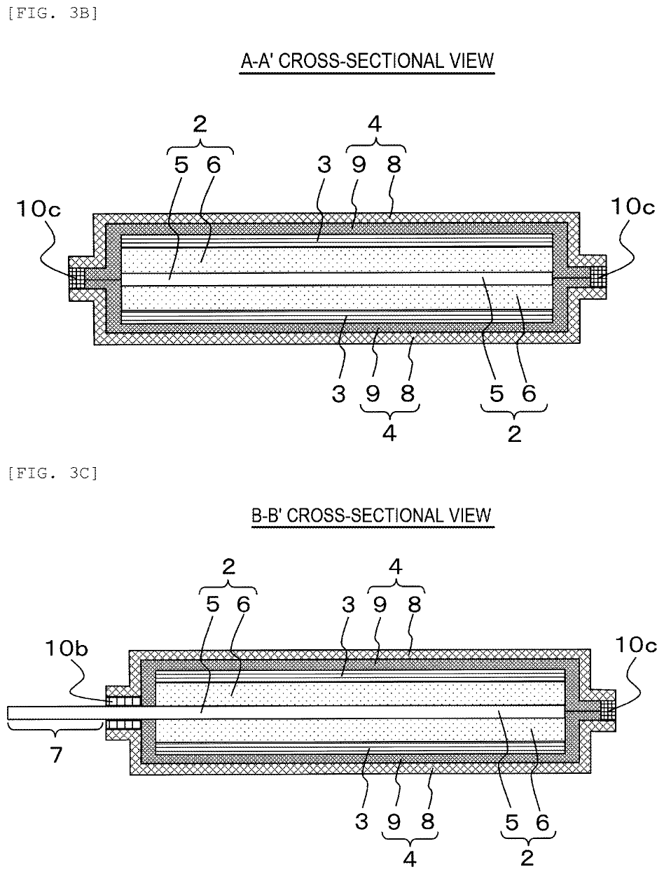

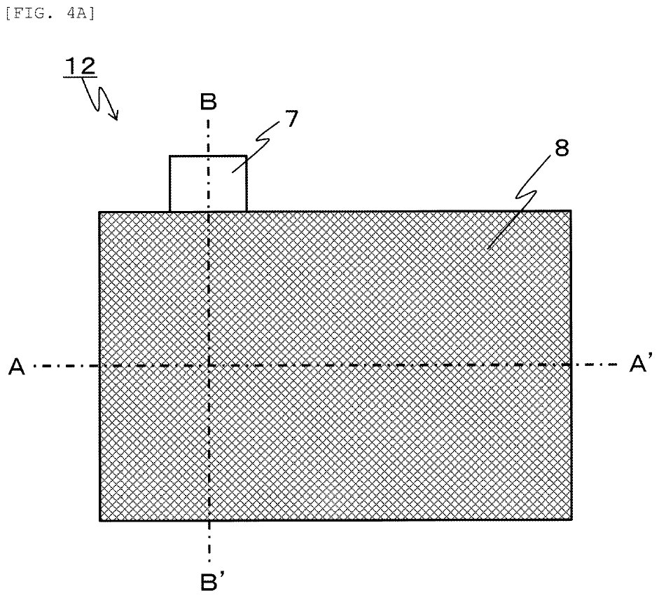

A battery cell sheet according to a second embodiment will be described with reference to FIGS. 3A to 3C. The same configurations as those of the first embodiment are denoted by the same reference numerals, and the description thereof is omitted.

A battery cell sheet 11 according to the present embodiment is characterized in that an end side portion other than the tab portion 7 is formed by the sealing portion 10c in which the facing semi-solid electrolyte layers 9 are integrated. As shown in FIGS. 3A to 3C, the facing semi-solid electrolyte layers 9 are heated and pressurized by the heat seal unit 111, so that the supporting materials of the semi-solid electrolyte layers 9 become dense, and the binder is melted, and a gap between the supporting materials is blocked. Accordingly, the sealing portion 10c is formed, and the facing semi-solid electrolyte layers 9 are integrated. Meanwhile, the sealing sheet 8 and the semi-solid electrolyte layers 9 are adhered only by a binder, and are not integrated by welding.

According to the present embodiment, the sealing sheet 8 is easily peeled off from the semi-solid electrolyte layer 9, and the productivity in manufacturing of the secondary battery is improved, compared with a case where the sealing portion 10a is formed by integrating the sealing sheets 8 by welding (first embodiment).

### Example 3

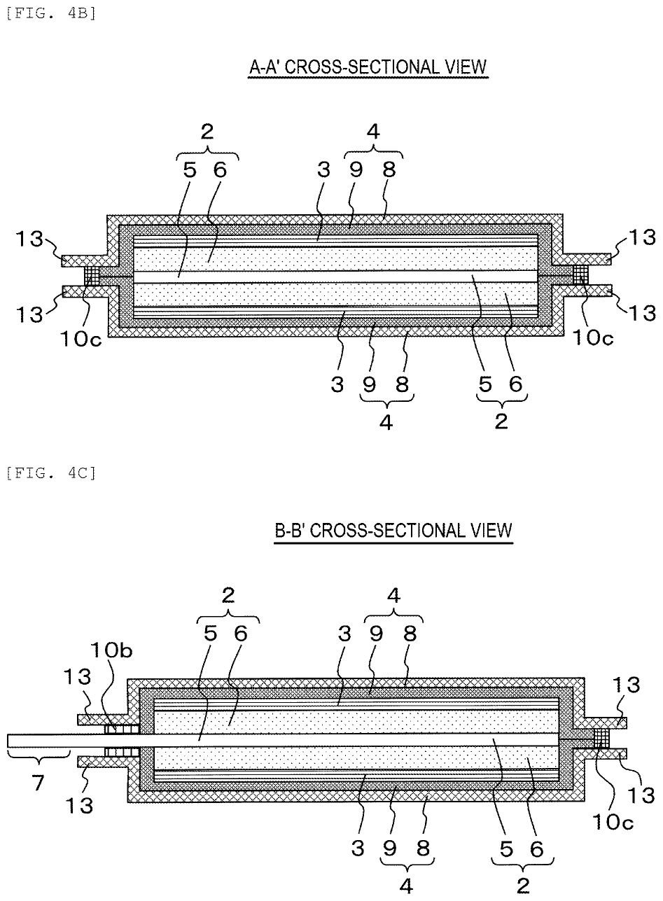

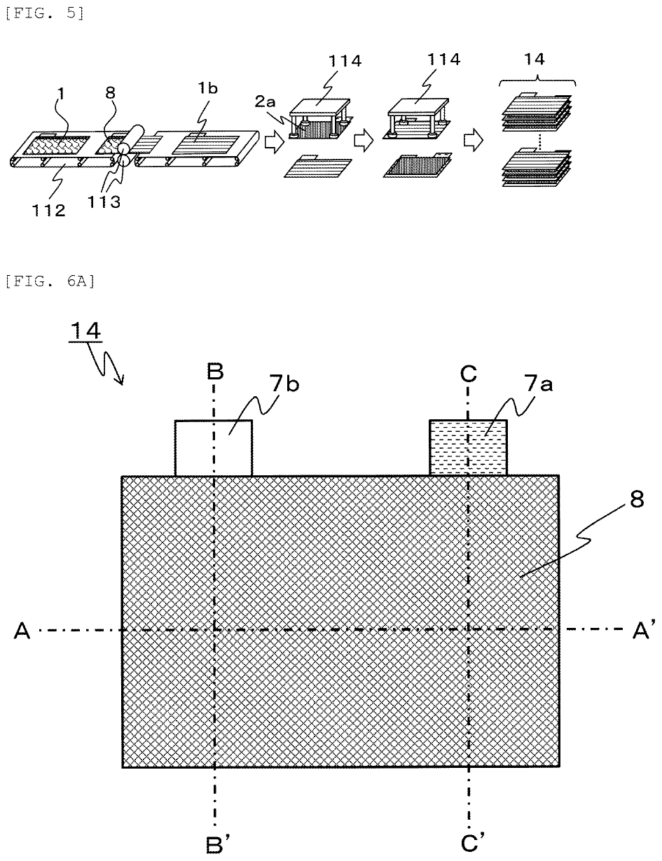

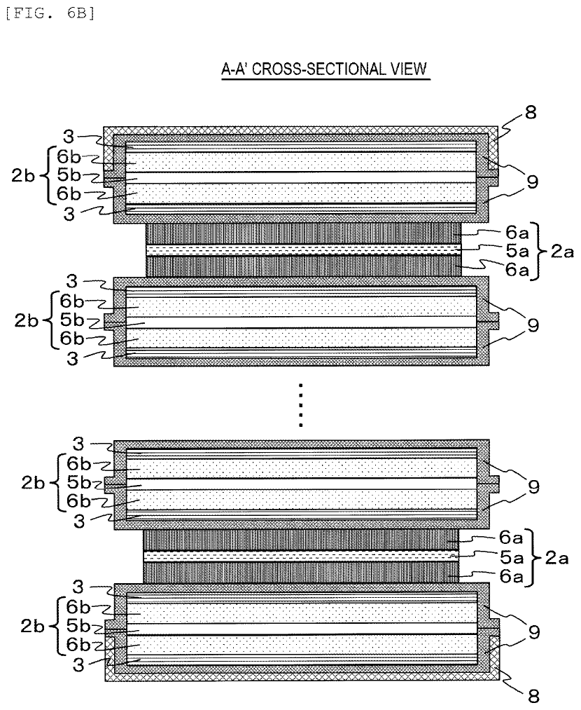

A battery cell sheet according to a third embodiment will be described with reference to FIGS. 4A to 4C. The same configurations as those of the first embodiment are denoted by the same reference numerals, and the description thereof is omitted.

A battery cell sheet 12 according to the present embodiment is characterized in that an outer edge of the end side portion is not coated with the semi-solid electrolyte layer 9, the sealing portion is not formed either, and a peeling starting portion 13 is included.

According to the present embodiment, the peeling starting portion 13 serving as a starting point of peeling is formed in advance, so that the sealing sheet 8 can be easily peeled off from the battery cell sheet 12 and the productivity in manufacturing of the secondary battery is improved, when the electrode laminated body is manufactured during the manufacturing of the secondary battery.

### Example 4

A method of manufacturing a secondary battery using the battery cell sheet described in the first embodiment will be described by taking a laminated secondary battery as an example. An example of a battery cell sheet using a negative electrode is shown below.

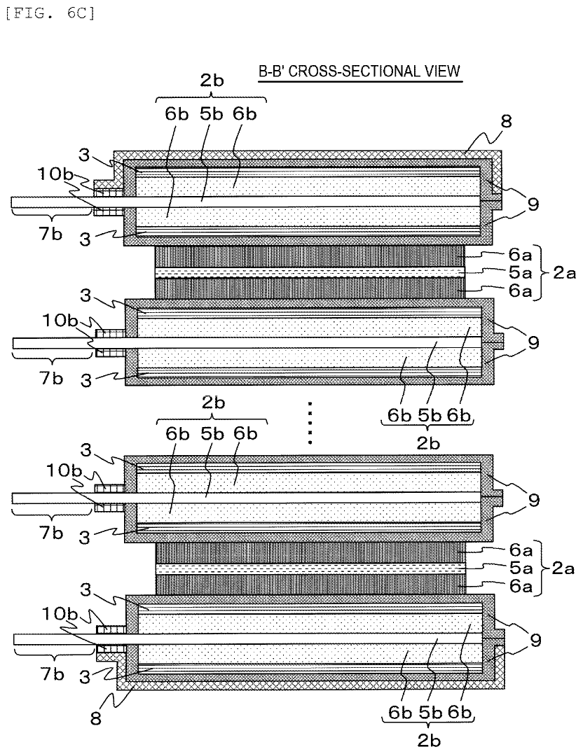

The battery cell sheet 1 is manufactured in a manner similar to that in the first embodiment. FIG. 5 is a schematic view showing a method of manufacturing an electrode laminated body in a secondary battery. In the battery cell sheet 1 used in this manufacturing step, the sealing portion 10a formed by integrating the sealing sheets 8 covering the battery cell sheet is cut off (the step is not shown) , and the battery cell sheet 1 is disposed on the transfer unit 112. The battery cell sheet 1 is transferred by the transfer unit 112 to a peeling roller 113. In the peeling roller 113, the sealing sheet 8 is peeled off by an adhesive method. Examples of the peeling roller 113 include, but are not limited to, a silicon rubber, a urethane rubber, and an acrylic rubber.

Next, the positive electrode 2a is laminated, by using the transfer unit 114, on a battery cell sheet 1b from which the sealing sheet 8 is peeled off. At this time, the non-aqueous solution 3 may be added to the positive electrode 2a or may not be added thereto. The non-aqueous solution 3 is preferably not added to the positive electrode 2a, from a viewpoint of handle-ability. Thereafter, the battery cell sheet 1b is laminated on the positive electrode 2a. Thereafter, the similar operation is repeated to form an electrode laminated body 14.

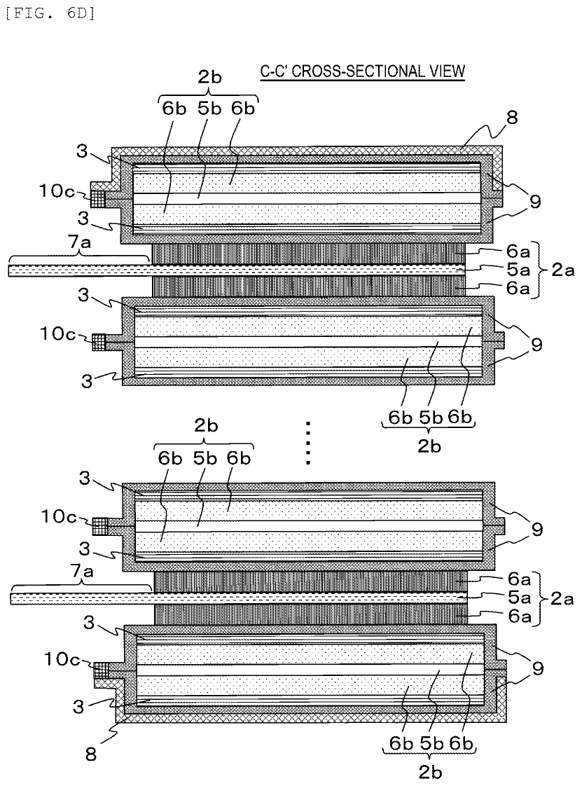

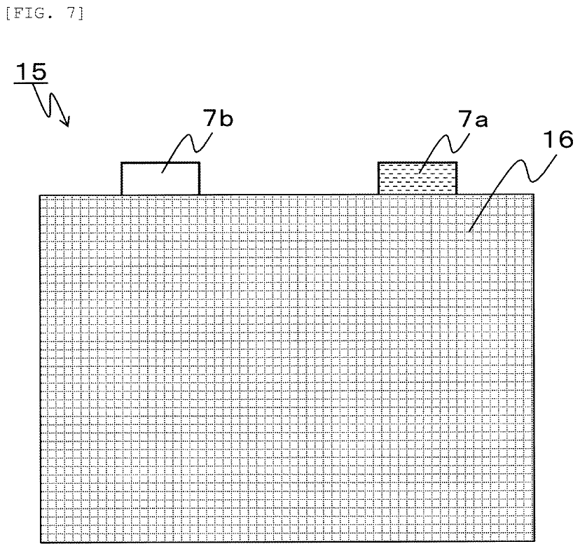

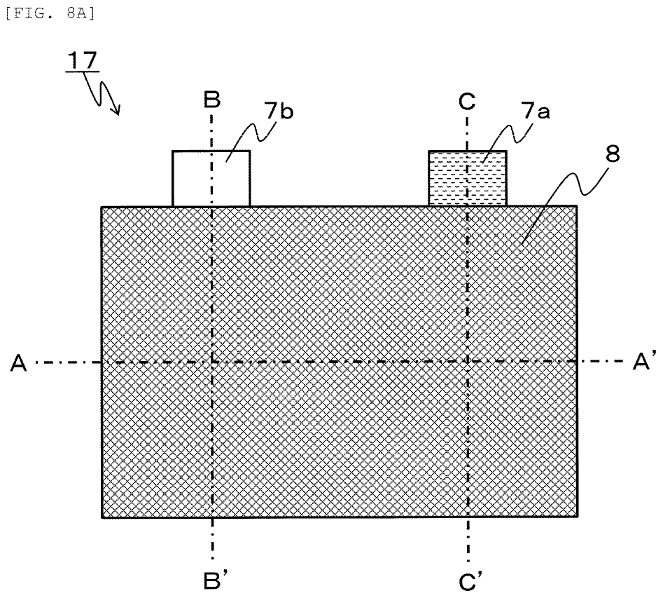

FIG. 6A is a plan view schematically showing the electrode laminated body 14. FIG. 6B is a cross-sectional view taken along a cutting line A-A′ in FIG. 6A, FIG. 6C is a cross-sectional view taken along a cutting line B-B′ in FIG. 6A, and FIG. 6D is a cross-sectional view taken along a cutting line C-C′ in FIG. 6A.

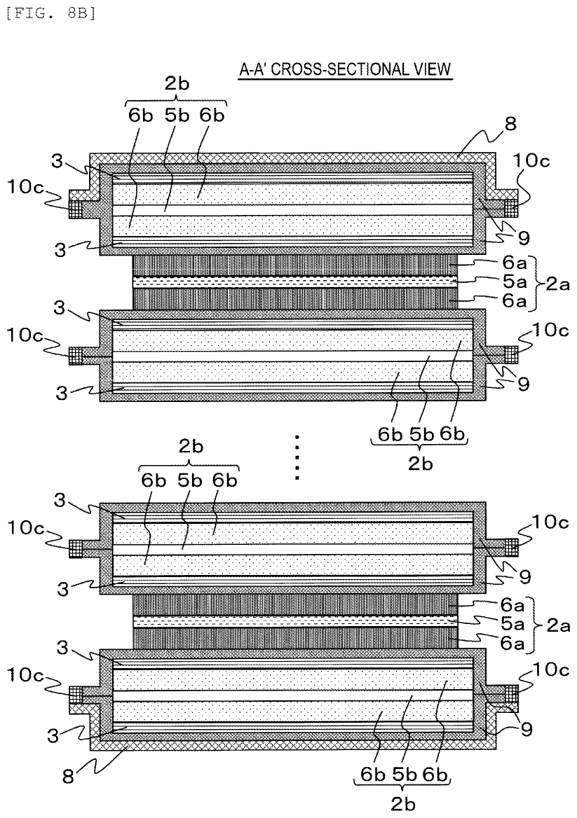

FIGS. 6B to 6D show only a part of the electrode laminated structure, and the number of laminated layers is not particularly limited. Thereafter, a plurality of negative electrode tabs 7b and a plurality of positive electrode tabs 7a are welded together. FIG. 7 is a plan view schematically showing a laminated secondary battery 15. The negative electrode tab 7b and the positive electrode tab 7a are stored in an outer package body 16 (for example, a general aluminum film container) in a manner of protruding out of the outer package body 16, thereby manufacturing a secondary battery.

According to the present embodiment, the battery cell sheet 1 in which the non-aqueous solution 3 is sealed by the sealing portion 10a, the sealing portion 10b, and the sealing portion 10c is used, so that the secondary battery can be manufactured without exposing the non-aqueous solution 3 to a dry atmosphere that is a battery manufacturing environment before lamination. Therefore, a secondary battery that can prevent a variation in an electrolyte composition due to volatilization of the electrolyte component and a decrease in battery performance can be manufactured.

### Example 5

A method of manufacturing a secondary battery using the battery cell sheet described in the second embodiment is described by taking a laminated lithium ion battery as an example. An example of a battery cell sheet using a negative electrode is shown below.

The battery cell sheet 11 is manufactured in a manner similar to that in the second embodiment. In the battery cell sheet 11, the sealing sheet 8 can be peeled off by the peeling roller without cutting off the sealing portion.

Next, the positive electrode 2a is laminated on the semi-solid electrolyte layer 9. At this time, the non-aqueous solution 3 may be added to the positive electrode 2a or may not be added thereto. The non-aqueous solution 3 is preferably not added to the positive electrode 2a, from the viewpoint of handle-ability. Thereafter, the similar operation is repeated to form an electrode laminated body 17.

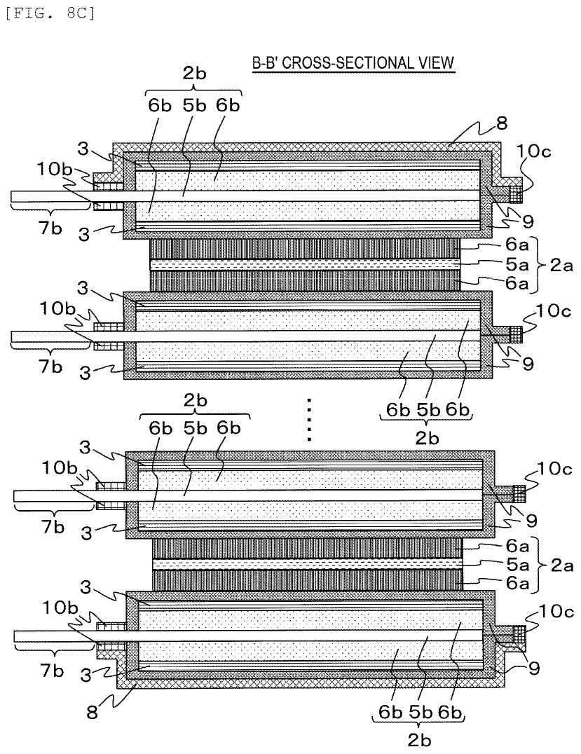

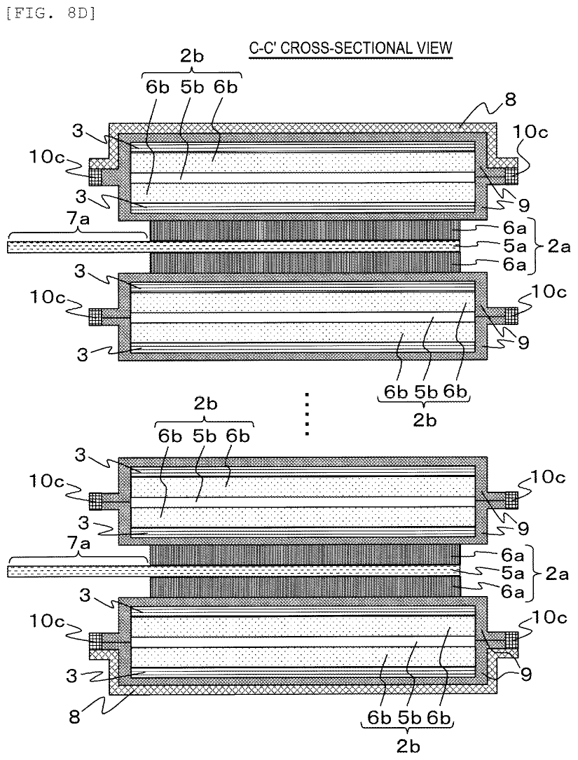

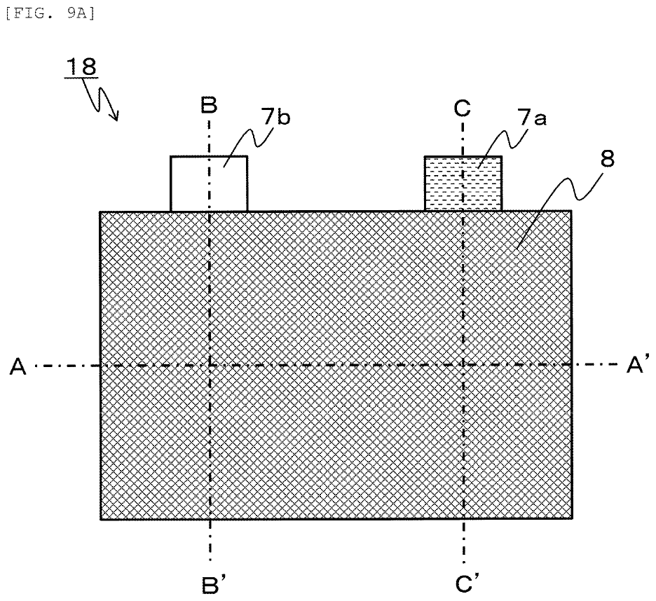

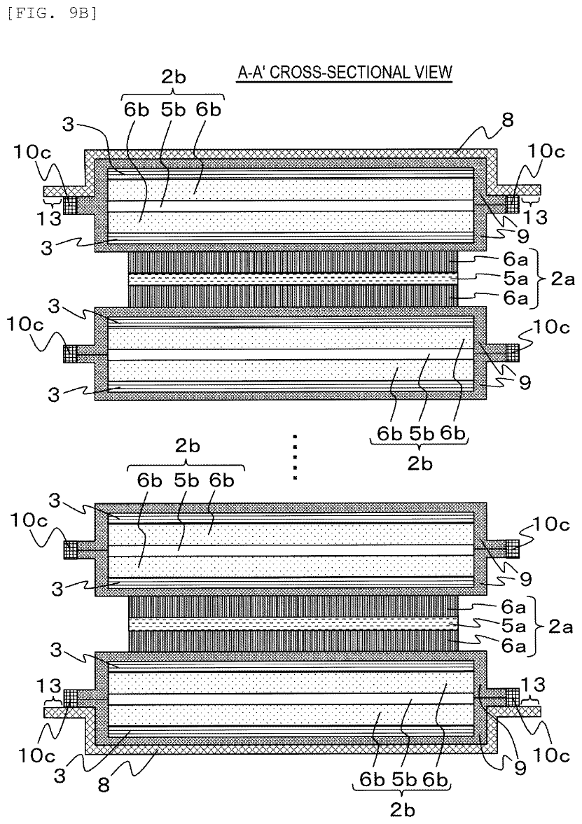

FIG. 8A is a plan view schematically showing the electrode laminated body 17. FIG. 8B is a cross-sectional view taken along a cutting line A-A′ in FIG. 8A, FIG. 8C is a cross-sectional view taken along a cutting line B-B′ in FIG. 8A, and FIG. 8D is a cross-sectional view taken along a cutting line C-C′ in FIG. 8A. FIGS. 8B to 8D show only a part of the electrode laminated structure, and the number of laminated layers is not particularly limited. The following operation is similar to that in the fourth embodiment.

According to the present embodiment, the sealing sheet 8 can be peeled off without cutting the sealing portion and the productivity in manufacturing of the secondary battery is improved, compared with the method of manufacturing a secondary battery using the battery cell sheet 1 that includes the sealing portion 10a formed by integrating the sealing sheets 8 by welding (fourth embodiment).

### Example 6

A method of manufacturing a secondary battery using the battery cell sheet described in the third embodiment is described as an example of a laminated lithium ion battery. An example of a battery cell sheet using a negative electrode is shown below.

The battery cell sheet 12 is manufactured in a manner similar to that in the third embodiment. In the battery cell sheet 12, the peeling starting portion 13 serving as a peeling starting point is formed in advance, and the sealing sheet 8 can be peeled off by the peeling roller without cutting off the sealing portion. Next, the positive electrode 2a is laminated on the semi-solid electrolyte layer 9. At this time, the non-aqueous solution 3 may be added to the positive electrode 2a or may not be added thereto. The non-aqueous solution 3 is preferably not added to the positive electrode 2a, from the viewpoint of handle-ability. Thereafter, the similar operation is repeated to form an electrode laminated body 18.

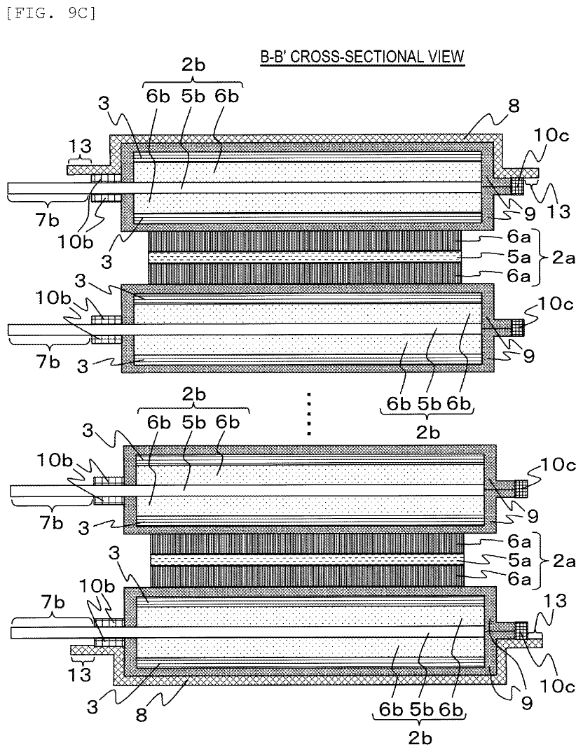

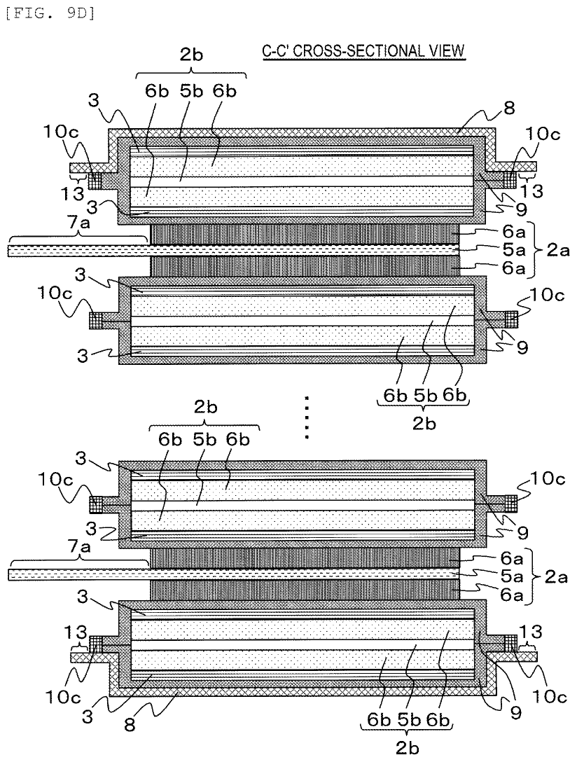

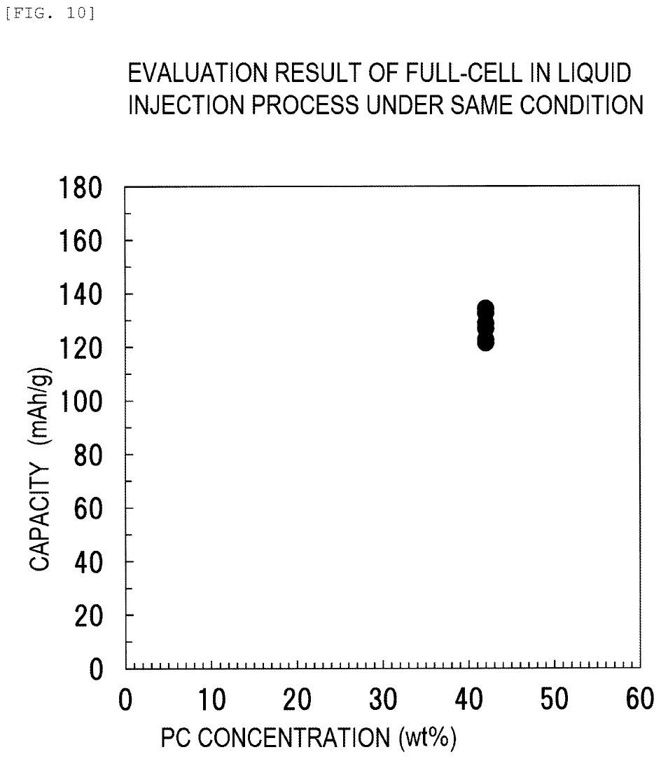

FIG. 9A is a plan view schematically showing the electrode laminated body 18. FIG. 9B is a cross-sectional view taken along a cutting line A-A′ in FIG. 9A, FIG. 9C is a cross-sectional view taken along a cutting line B-B′ in FIG. 9A, and FIG. 9D is a cross-sectional view taken along a cutting line C-C′ in FIG. 9A. FIGS. 9B to 9D show only a part of the electrode laminated structure, and the number of laminated layers is not particularly limited. The following operation is similar to that in the fourth embodiment.

According to the present embodiment, the sealing sheet 8 can be peeled off without cutting the sealing portion and the productivity in manufacturing of the secondary battery is improved, compared with the method of manufacturing a secondary battery using the battery cell sheet 1 that includes the sealing portion 10a formed by integrating the sealing sheets 8 by welding (fourth embodiment).

### Example 7

Propylene carbonate that improves ionic conductivity in the electrolyte and vinylene carbonate that prevents a reductive decomposition reaction of the electrolyte on a negative electrode surface are main additives related to the performance of the secondary battery disclosed in the fourth to sixth embodiments. The present inventor of the application clarifies the proper addition amount of both additives by preparing model cells and performing evaluation experiments.

In order to test the performance of only a positive electrode and a negative electrode, a half-cell of a combination of a positive electrode and a Li metal and a half-cell of a combination of a negative electrode and a Li metal were separately prepared with an electrolyte sheet interposed therebetween. A full-cell of a combination of the positive electrode and the negative electrode was prepared with an electrolyte sheet interposed therebetween.

The evaluation experiments were performed by reproducing the same conditions in the following cases: (1) a gap between electrodes was filled with a non-aqueous solution by a liquid injection process; and (2) when constructing the battery cell sheet disclosed in the first to sixth embodiments, the non-aqueous solution 3 coated onto the surface of the semi-solid electrolyte sheet 4 on which the semi-solid electrolyte layer 9 was formed was combined with the non-aqueous solution 3 added to the surface of the electrode 2 on which the electrode mixture layer 6 was formed, and the semi-solid electrolyte sheet 4 and the electrode 2 were laminated to construct a battery cell sheet.

### <<Method of Manufacturing Positive Electrode in Liquid Injection Process>>

A method of manufacturing the positive electrode will be described. LiNi_{1/3}Co_{1/3}Mn_{1/3}O₂ was used as a positive electrode active material, acetylene black was used as a conductive assistant, and a vinylidene fluoride-hexafluoropropylene copolymer was used as a binder. The positive electrode active material, the conductive assistant, and the binder were mixed so as to make the weight percentages thereof to be 84 wt %, 7 wt %, and 9 wt %, respectively, and further the mixture is dispersed in N-methyl-2-pyrrolidone (NMP), so as to prepare a positive electrode slurry. The positive electrode slurry was coated onto an aluminum foil so as to make a coating amount of the solid component to be 19 mg/cm², and was dried in a hot air drying furnace at 120° C. for 10 minutes. Next, roll pressing was performed to adjust a density of a positive electrode coating layer to 2.8 g/cm³.

### <<Method of Manufacturing Semi-Solid Electrolyte Sheet in Liquid Injection Process>>

A method of manufacturing the semi-solid electrolyte sheet will be described. First, (CF₃SO₂)₂NLi and tetraethylene glycol dimethyl ether were mixed at a molar ratio of 1:1 to prepare an electrolytic solution. In a globe box with an argon atmosphere, the electrolytic solution and SiO₂ nanoparticles (particle size: 7 nm) were mixed at a volume fraction of 80:20, methanol was added thereto, and then the mixture was stirred for 30 minutes by using a magnet stirrer. Thereafter, the obtained mixed liquid was spread to a petri dish, and methanol was distilled off to obtain a powdery semi-solid electrolyte. 5 mass % of PTFE powder was added to the powdery semi-solid electrolyte, and the mixed powder was stretched with good mixing and pressurization, so as to obtain a semi-solid electrolyte sheet having a thickness of about 200 μm.

### <<Method of Manufacturing Negative Electrode in Liquid Injection Process>>

A method of manufacturing the negative electrode will be described. Graphite was used as a negative electrode active material, acetylene black was used as a conductive assistant, and a vinylidene fluoride-hexafluoropropylene copolymer was used as a binder. The negative electrode active material, the conductive assistant, and the binder were mixed so as to make the weight percentages thereof to be 88 wt %, 2 wt %, and 10%, respectively, and further the mixture was dispersed in N-methyl-2-pyrrolidone (NMP), so as to prepare a negative electrode slurry. The negative electrode slurry was coated onto a copper foil so as to make the coating amount of the solid component to be 8.3 mg/cm², and was dried in a hot air drying furnace at 120° C. for 10 minutes. Next, roll pressing was performed to adjust a density of the negative electrode coating layer to 1.6 g/cm³.

### <<Method of Evaluating Positive Electrode Half-Cell in Liquid Injection Process>>

An initial capacity evaluation was performed by the method shown below. A lithium metal was used as a counter electrode. A positive electrode, a semi-solid electrolyte sheet, and the lithium metal were punched to have a diameter of φ16 mm, and were laminated so as to interpose the semi-solid electrolyte sheet between the positive electrode and the lithium metal. Thereafter, a non-aqueous solution was injected to an electrolytic solution obtained by mixing (CF₃SO₂) ₂NLi and tetraethylene glycol dimethyl ether at a molar ratio of 1:1, so as to prepare a model cell. In the non-aqueous solution, 42 wt % {Here, the denominator, from which 42 wt % is calculated, is equal to (the weight of the electrolytic solution in the semi-solid electrolyte sheet)+(the weight of the added non-aqueous solution), and the weight of the entire liquid components present in the model cell is set as the denominator.} of propylene carbonate (PC) as a low viscosity solvent, 3 wt % of vinylene carbonate (VC) as a negative electrode interface stabilizer, and 2.5 wt % of tetrabutylammonium hexafluorophosphate (NBu₄PF₆) as a corrosion inhibitor were added.

First, constant current charging was performed at 0.05 C until the voltage reached 4.2 V. {Here, for C, a current value, which is obtained when a battery having a nominal capacity is discharged (charged) and the discharging (charging) is completed in one hour, is set as 1 C. C is used as a general unit fora battery. The above 0.05 C indicates a current value obtained when discharging (charging) is completed in 20 hours. The nominal capacity of the positive electrode half-cell, the negative electrode half-cell, and the full-cell of the present embodiment, which is a value theoretically calculated based on the amount of the active material contained in each of the positive electrode and the negative electrode, is used to perform the evaluation experiment.}

Thereafter, constant voltage charging was performed at a voltage of 4.2 V until the current value reached 0.005 C. Then, the charging was stopped for one hour in an open circuit state, and constant current discharging was performed at 0.05 C until the voltage reached 2.7 V. The discharging capacity obtained at this time was defined as initial capacity. The initial capacity was converted to a value per weight of the positive electrode active material used.

### <<Method of Evaluating Negative Electrode Half-Cell in Liquid Injection Process>>

An initial capacity evaluation was performed by the method shown below. A lithium metal was used as a counter electrode. A negative electrode, a semi-solid electrolyte sheet, and the lithium metal were punched to have a diameter of φ16 mm, and were laminated so as to interpose the semi-solid electrolyte sheet between the negative electrode and the lithium metal. Thereafter, a non-aqueous solution was injected to an electrolytic solution obtained by mixing (CF₃SO₂) ₂NLi and tetraethylene glycol dimethyl ether at a molar ratio of 1:1, so as to prepare a model cell. In the non-aqueous solution, 42 wt % of propylene carbonate (PC) as a low viscosity solvent, 3 wt % of vinylene carbonate (VC) as a negative electrode interface stabilizer, and 2.5 wt % of tetrabutylammonium hexafluorophosphate (NBu₄PF₆) as a corrosion inhibitor were added.

First, constant current charging was performed at 0.05 C until the voltage reached 0.005 V. Thereafter, constant voltage charging was performed at a voltage of 0.005 V until the current value reached 0.005 C. Then, the charging was stopped for one hour in an open circuit state, and constant current discharging was performed at 0.05 C until the voltage reached 1.5 V. The discharging capacity obtained at this time was defined as initial capacity. The initial capacity was converted to a value per weight of the negative electrode active material used.

### <<Method of Evaluating Full-Cell in Liquid Injection Process>>

An initial capacity evaluation was performed by the method shown below. A positive electrode and a semi-solid electrolyte sheet were punched to have a diameter of φ16 mm, and a negative electrode was punched to have a diameter of φ 18 mm. The positive electrode, the semi-solid electrolyte sheet, and the negative electrode were laminated so as to interpose the semi-solid electrolyte sheet between the positive electrode and the negative electrode. Thereafter, a non-aqueous solution was injected to an electrolytic solution obtained by mixing (CF₃SO₂)₂NLi and tetraethylene glycol dimethyl ether at a molar ratio of 1:1, so as to prepare. In the non-aqueous solution, 42 wt % of propylene carbonate (PC) as a low viscosity solvent, 3 wt % of vinylene carbonate (VC) as a negative electrode interface stabilizer, and 2.5 wt % of tetrabutylammonium hexafluorophosphate (NBu₄PF₆) as a corrosion inhibitor were added.

First, constant current charging was performed at 0.05 C until the voltage reached 4.2 V. Thereafter, constant voltage charging was performed at a voltage of 4.2 V until the current value reached 0.005 C. Then, the charging was stopped for one hour in an open circuit state, and constant current discharging was performed at 0.05 C until the voltage reached 2.7 V. The discharging capacity obtained at this time was defined as initial capacity. The initial capacity was converted to a value per weight of the positive electrode used.

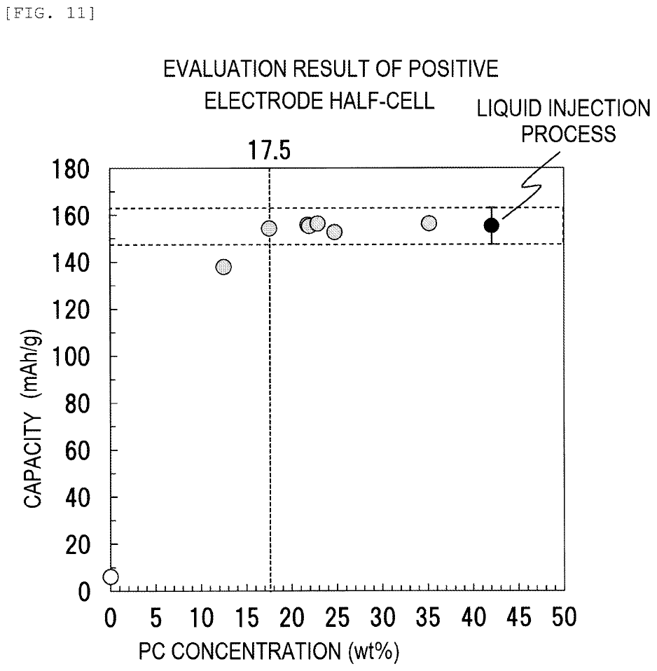

FIG. 10 shows results of performing the evaluation on the full-cell in the liquid injection process for five times under the same condition. The initial capacity was 121.4 mAh/g, 122.6 mAh/g, 132.6 mAh/g, 134.3 mAh/g, and 126.8 mAh/g, and an experimental variation was ±5%.

### <<Method of Manufacturing Positive Electrode in Processes of First to Sixth Embodiments>>

A method of manufacturing the positive electrode will be described. LiNi_{1/3}Co_{1/3}Mn_{1/3}O₂ was used as a positive electrode active material, acetylene black was used as a conductive assistant, a vinylidene fluoride-hexafluoropropylene copolymer was used as a binder, and an electrolytic solution obtained by mixing (CF₃SO₂)₂NLi and tetraethylene glycol dimethyl ether at a molar ratio of 1:1 was used as an electrolytic solution. The positive electrode active material, the conductive assistant, the binder, and the electrolytic solution were mixed so as to make the weight percentages thereof to be 74 wt %, 6 wt %, 8wt %, and 12 wt %, respectively, and the mixture was dispersed in N-methyl-2-pyrrolidone (NMP), so as to prepare a positive electrode slurry. The positive electrode slurry was coated onto an aluminum foil so as to make the coating amount of the solid component to be 19 mg/cm², and was dried in a hot air drying furnace at 100° C. for 10 minutes. Next, roll pressing was performed to adjust a density of a positive electrode coating layer to 2.8 g/cm³.

### <<Method of Manufacturing Semi-Solid Electrolyte Sheet in Processes of First to Sixth Embodiments>>

A method of manufacturing the semi-solid electrolyte sheet will be described. First, (CF₃SO₂)₂NLi and tetraethylene glycol dimethyl ether were mixed at a molar ratio of 1:1 to prepare an electrolytic solution. In a globe box with an argon atmosphere, the electrolytic solution and SiO₂ nanoparticles (particle size: 7 nm) were mixed at a volume fraction of 80:20, methanol was added thereto, and then the mixture was stirred for 30 minutes by using a magnet stirrer. Thereafter, the obtained mixed liquid was spread to a petri dish, and methanol was distilled off to obtain a powdery semi-solid electrolyte. 5 mass % of PTFE powder was added to the powdery semi-solid electrolyte, and the mixed powder was stretched with good mixing and pressurization, so as to obtain a semi-solid electrolyte sheet having a thickness of about 200 μm.

### <<Method of Manufacturing Negative Electrode in Processes of First to Sixth Embodiments>>

A method of manufacturing the negative electrode will be described. Graphite was used as a negative electrode active material, acetylene black was used as a conductive assistant, a vinylidene fluoride-hexafluoropropylene copolymer was used as a binder, and an electrolytic solution obtained by mixing (CF₃SO₂)₂NLi and tetraethylene glycol dimethyl ether at a molar ratio of 1:1 was used as an electrolytic solution. The negative electrode active material, the conductive assistant, the binder, and the electrolytic solution were mixed so as to make the weight percentages thereof to be 77 wt %, 2 wt %, 9 wt %, and 12 wt %, respectively, and the mixture was dispersed in N-methyl-2-pyrrolidone (NMP), so as to prepare a negative electrode slurry. The negative electrode slurry was coated onto a copper foil so as to make the coating amount of the solid component to be 8.3 mg/cm², and was dried in a hot air drying furnace at 100° C. for 10 minutes. Next, roll pressing was performed to adjust the density of the negative electrode coating layer to 1.7 g/cm³.

### <<Method of Evaluating Positive Electrode Half-Cell in Processes of First to Sixth Embodiments>>

An initial capacity evaluation was performed by the method shown below. A lithium metal was used as a counter electrode. A positive electrode, a semi-solid electrolyte sheet, and the lithium metal were punched to have a diameter of φ16 mm. Thereafter, a non-aqueous solution was added (dropped and coated) onto the positive electrode so as to make the weight percentage of propylene carbonate in the model cell to be 12.5 wt % to 42 wt % {Here, the denominator in the case of calculating the weight percentage of propylene carbonate is equal to (the weight of the electrolytic solution in the electrode)+(the weight of the electrolytic solution in the semi-solid electrolyte sheet)+(the weight of the added non-aqueous solution) , and the weight of the entire liquid components present in the model cell is set as the denominator.}. The non-aqueous solution contains 0 wt % to 29.6 wt % of (CF₃SO₂)₂NLi, 0 wt % to 22.9 wt % of tetraethylene glycol dimethyl ether, 42 wt % to 88.4 wt % of propylene carbonate, 3 wt % to 6.3 wt % of vinylene carbonate, and 2.5 wt % to 5.3 wt % of tetrabutylammonium hexafluorophosphate. Next, the positive electrode, the semi-solid electrolyte sheet, and the lithium metal are laminated so as to interpose the semi-solid electrolyte layer between the positive electrode and the lithium metal, so as to prepare a model cell.

First, constant current charging was performed at 0.05 C until the voltage reached 4.2 V. Thereafter, constant voltage charging was performed at a voltage of 4.2 V until the current value reached 0.005 C. Then, the charging was stopped for one hour in an open circuit state, and constant current discharging was performed at 0.05 C until the voltage reached 2.7 V. The discharging capacity obtained at this time was defined as initial capacity. The initial capacity was converted to a value per weight of the positive electrode active material used.

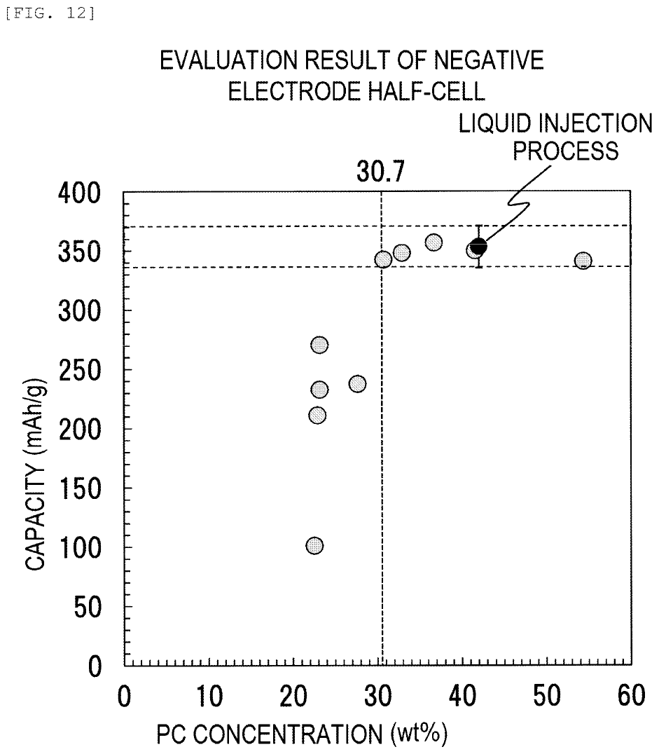

FIG. 11 shows results of the weight percentage of propylene carbonate in the model cell and initial capacity in evaluation experiments of the positive electrode half-cell in the processes of the first to the sixth embodiments. An evaluation result showing capacity which falls within a range of ±5% of the evaluation result in the liquid injection process and is equal to or higher than that of the liquid injection process corresponds to a case where the concentration of propylene carbonate is 17.5 wt % or more.

### <<Method of Evaluating Negative Electrode Half-Cell in Processes of First to Sixth Embodiments>>

An initial capacity evaluation was performed by the method shown below. A lithium metal was used as a counter electrode. A negative electrode, a semi-solid electrolyte sheet, and the lithium metal were punched to have a diameter of φ16 mm. Thereafter, a non-aqueous solution was added (dropped and coated) onto the negative electrode so as to make the weight percentage of propylene carbonate in the model cell to be 22.5 wt % to 54.4 wt % {Here, the denominator in the case of calculating the weight percentage of propylene carbonate is equal to (the weight of the electrolytic solution in the electrode)+(the weight of the electrolytic solution in the semi-solid electrolyte sheet)+(the weight of the added non-aqueous solution) , and the weight of the entire liquid components present in the model cell is set as the denominator.}, and to make the weight percentage of vinylene carbonate to be 1 wt % to 5 wt % {Here, the denominator in the case of calculating the weight percentage of vinylene carbonate is equal to (the weight of the electrolytic solution in the electrode)+(the weight of the electrolytic solution in the semi-solid electrolyte sheet)+(the weight of the added non-aqueous solution), and the weight of the entire liquid components present in the model cell is set as the denominator.}. The non-aqueous solution contains 0 wt % to 29.6 wt % of (CF₃SO₂)₂NLi, 0 wt % to 22.9 wt % of tetraethylene glycol dimethyl ether, 42 wt % to 89.5 wt % of propylene carbonate, 2.1 wt % to 10.6 wt % of vinylene carbonate, and 0 wt % to 5.3 wt % of tetrabutylammonium hexafluorophosphate. Next, the negative electrode, the semi-solid electrolyte sheet, and the lithium metal are laminated so as to interpose the semi-solid electrolyte sheet between the negative electrode and the lithium metal, so as to prepare a model cell.

First, constant current charging was performed at 0.05 C until the voltage reached 0.005 V. Thereafter, constant voltage charging was performed at a voltage of 0.005 V until the current value reached 0.005 C. Then, the charging was stopped for one hour in an open circuit state, and constant current discharging was performed at 0.05 C until the voltage reached 1.5 V. The discharging capacity obtained at this time was defined as initial capacity. The initial capacity was converted to a value per weight of the negative electrode used.

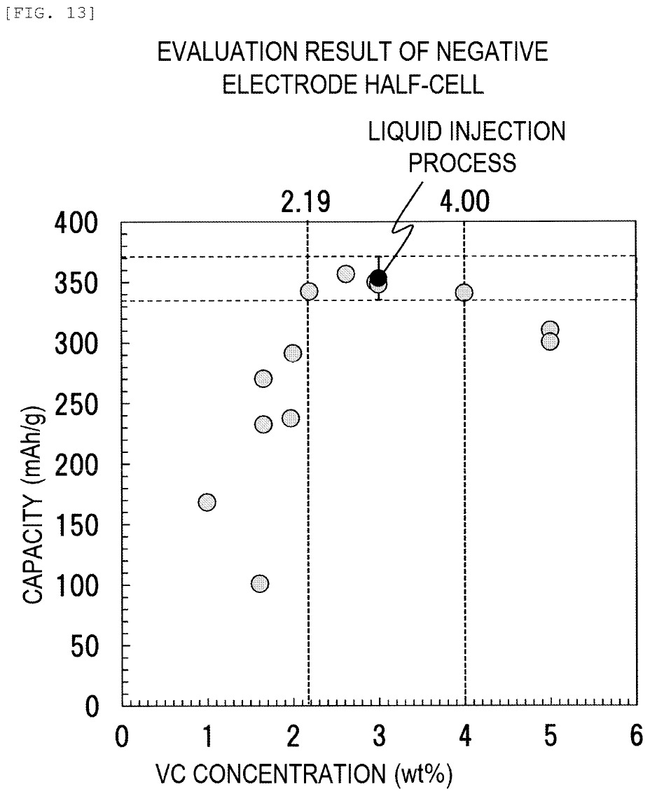

FIG. 12 shows results of the weight percentage of propylene carbonate in the model cell and initial capacity in evaluation experiments of the negative half-cell in the processes of the first to sixth embodiments. An evaluation result showing capacity which falls within a range of ±5% of the evaluation result in the liquid injection process and is equal to or higher than that of the liquid injection process corresponds to a case where the concentration of propylene carbonate is 30.7 wt % or more.

FIG. 13 shows results of the weight percentage of vinylene carbonate in the model cell and the initial capacity in evaluation experiments of the negative half-cell in the processes of the first to sixth embodiments. An evaluation result showing capacity which falls within a range of ±5% of the evaluation result in the liquid injection process and is equal to or higher than that of the liquid injection process corresponds to a case where the concentration of vinylene carbonate is in a range of 2.19 wt % to 4.00 wt %.

### <<Method of Evaluating Full-Cell in Processes of First to Sixth Embodiments>>

An initial capacity evaluation was performed by the method shown below. A positive electrode, a semi-solid electrolyte sheet were punched to have a diameter of φ16 mm, and a negative electrode was punched to have a diameter of φ18 mm. Thereafter, a non-aqueous solution was added (dropped and coated) onto the negative electrode and the semi-solid electrolyte sheet so as to make the weight percentage of propylene carbonate in the model cell to be 41.3 wt % and 54.4% {Here, the denominator in the case of calculating the weight percentage of propylene carbonate is equal to (the weight of the electrolytic solution in the electrode)+(the weight of the electrolytic solution in the semi-solid electrolyte sheet)+(the weight of the added non-aqueous solution), and the weight of the entire liquid components present in the model cell is set as the denominator.}, and to make the weight percentage of vinylene carbonate to be 2.9 wt % and 4 wt % {Here, the denominator in the case of calculating the weight percentage of vinylene carbonate is equal to (the weight of the electrolytic solution in the electrode)+(the weight of the electrolytic solution in the semi-solid electrolyte sheet)+(the weight of the added non-aqueous solution), and the weight of the entire liquid components present in the model cell is set as the denominator.}. The non-aqueous solution contains 88.4 wt % of propylene carbonate, 6.3 wt % of vinylene carbonate, and 5.3 wt % of tetrabutylammonium hexafluorophosphate. Next, the positive electrode, the semi-solid electrolyte sheet, and the negative electrode are laminated so as to interpose the semi-solid electrolyte layer between the positive electrode and the negative electrode, so as to prepare a model cell.

First, constant current charging was performed at 0.05 C until the voltage reached 4.2 V. Thereafter, constant voltage charging was performed at a voltage of 4.2 V until the current value reached 0.005 C. Then, the charging was stopped for one hour in an open circuit state, and constant current discharging was performed at 0.05 C until the voltage reached 2.7 V. The discharging capacity obtained at this time was defined as initial capacity. The initial capacity was converted to a value per weight of the positive electrode used.

The evaluation results of the full-cell in the processes of the first to sixth embodiments showed that the initial capacity was 122.7 mAh/g in a case where the concentrations of propylene carbonate and vinylene carbonate in the model cell were respectively 41.3 wt % and 2.9 wt %. In addition, the initial capacity was 122.4 mAh/g in a case where the concentrations of propylene carbonate and vinylene carbonate in the model cell were respectively 54.4 wt % and 4.00 wt %. The capacity equal to that of the liquid injection process was obtained in all the processes of the first to sixth embodiments.

As described above, when the concentrations of propylene carbonate and vinylene carbonate in the model cell were in the ranges of 30.7 wt % or more and 2.19 wt % to 4.00 wt %, respectively, the performance equivalent to that of the liquid injection process was obtained.

Therefore, in the laminated secondary batteries shown in the fourth to sixth embodiments, the addition amounts of propylene carbonate and vinylene carbonate, which are used for optimizing the performance of the secondary battery, are preferably defined by making the concentrations of propylene carbonate and vinylene carbonate to respectively fall within ranges of 30.7 wt % or more and 2.19 wt % to 4.00 wt %, based on the total weight of the entire liquid components in the secondary battery which is equal to (the total weight of the electrolytic solution in the electrode)+(the total weight of the electrolytic solution in the semi-solid electrolyte sheet)+(the total weight of the added non-aqueous solution).

The invention made by the present inventors has been described in detail based on the embodiments thereof, but the invention is not limited to the above embodiments, and as a matter of course various modifications can be made without departing from the scope of the invention.

### REFERENCE SIGN LIST

1, 11, 12 battery cell sheet

2 electrode

2a positive electrode

2b negative electrode

3 non-aqueous solution

4 semi-solid electrolyte sheet

5 current collector

5a positive electrode current collector

5b negative electrode current collector

6 electrode mixture layer

6a positive electrode mixture layer

6b negative electrode mixture layer

7 tab portion

7a positive electrode tab portion

7b negative electrode tab portion

8 sealing sheet

9 semi-solid electrolyte layer

10 sealing portion

10a sealing portion

10b sealing portion

10c sealing portion

13 peeling starting portion

14, 17, 18 electrode laminated body

15 laminated secondary battery

16 outer package body

100, 104, 110, 112, 114 transfer unit

101, 108 coating unit

102 roller

103 liquid tank

105 lamination roller

106 semi-solid electrolyte roller

107 guide roller

109 cutting unit

111 heat seal unit

113 peeling roller

1. A battery cell sheet comprising:
an electrode that includes an electrode current collector, and electrode mixture layers respectively formed on both upper and lower surfaces of the electrode current collector;
a first semi-solid electrolyte layer and a second semi-solid electrolyte layer that are respectively laminated on upper and lower surfaces of the electrode;
a first sealing sheet and a second sealing sheet that respectively adhere to and cover a surface of each semi-solid electrolyte layer opposite to a surface thereof laminated with the electrode, and seal the electrode with the first semi-solid electrolyte layer and the second semi-solid electrolyte layer;
a non-aqueous solution that is provided between each of the electrode mixture layers of the electrode and each semi-solid electrolyte layer, and
a sealing portion that is provided at an end side portion of each of the first sealing sheet and the second sealing sheet.

2. The battery cell sheet according to claim 1, wherein the sealing portion includes a first sealing portion in which the first sealing sheet and the second sealing sheet are integrated by welding, a second sealing portion in which the first semi-solid electrolyte layer and the second semi-solid electrolyte layer are integrated by welding, and a third sealing portion in which the first semi-solid electrolyte layer and the second semi-solid electrolyte layer adhere to a tab portion of the electrode current collector.

3. The battery cell sheet according to claim 1, wherein the sealing portion includes a second sealing portion in which the first semi-solid electrolyte layer and the second semi-solid electrolyte layer are integrated by welding and a third sealing portion in which the first semi-solid electrolyte layer and the second semi-solid electrolyte layer adhere to a tab portion of the electrode current collector.

4. The battery cell sheet according to claim 3, wherein the first sealing sheet and the second sealing sheet extend to an outer edge in the second sealing portion and the third sealing portion.

5. The battery cell sheet according to claim 1, wherein the sealing sheet is formed of a resin film such as polyethylene terephthalate, polyethylene, polypropylene and polyimide, or a film obtained by laminating the resin film and a metal foil such as stainless steel, aluminum and copper.

6. The battery cell sheet according to claim 1, wherein the non-aqueous solution contains at least one of a low viscosity solvent and a negative electrode interface stabilizer.

7. The battery cell sheet according to claim 6, wherein the low viscosity solvent is propylene carbonate, ethylene carbonate, or a mixture thereof.

8. The battery cell sheet according to claim 6, wherein the negative electrode interface stabilizer is vinylene carbonate, fluoroethylene carbonate, or a mixture thereof.

9. (canceled)

10. A device of manufacturing a battery cell sheet comprising:
a first coating unit that adds a non-aqueous solution to surfaces of electrode mixture layers of an electrode, the electrode being formed by applying the electrode mixture layer on upper and lower surfaces of an electrode current collector;
a second coating unit that transfers, by roller winding, a semi-solid electrolyte sheet including a semi-solid electrolyte layer and a sealing sheet, and adding the non-aqueous solution to the semi-solid electrolyte layer;
a lamination roller unit that laminates the electrode to a first semi-solid electrolyte sheet and a second semi-solid electrolyte sheet, such that a first electrode mixture layer on an upper surface side of the electrode faces the semi-solid electrolyte layer of the first semi-solid electrolyte sheet supplied to the upper surface side of the electrode, and a second electrode mixture layer on a lower surface side of the electrode faces the semi-solid electrolyte layer of the second semi-solid electrolyte sheet supplied to the lower surface side of the electrode;
a cutting unit that cuts the first semi-solid electrolyte sheet and the second semi-solid electrolyte sheet; and
a heat seal unit that heats and pressurizes an end side portion of a laminated body, which is obtained by laminating the electrode to the first semi-solid electrolyte sheet and the second semi-solid electrolyte sheet, to form a sealing portion.

11. A secondary battery comprising:
a battery cell sheet including an electrode that includes an electrode current collector of first polarity, and electrode mixture layers respectively formed on both upper and lower surfaces of the electrode current collector of first polarity, a first semi-solid electrolyte layer and a second semi-solid electrolyte layer that are respectively laminated on upper and lower surfaces of the electrode, a first sealing sheet and a second sealing sheet that respectively adhere to and cover a surface of each semi-solid electrolyte layer opposite to a surface thereof laminated with the electrode, and seal the electrode with the first semi-solid electrolyte layer and the second semi-solid electrolyte layer, a non-aqueous solution that is provided between each of the electrode mixture layers of the electrode and each semi-solid electrolyte layer, and a sealing portion that is provided at an end side portion of each of the first sealing sheet and the second sealing sheet, wherein
the battery cell sheet is placed with a sealing sheet on at least an upper laminated surface side peeling off,
an electrode is laminated over the battery cell sheet, the electrode including an electrode current collector of second polarity different from the first polarity, and electrode mixture layers respectively formed on both upper and lower surfaces of the electrode current collector of second polarity,
the battery cell sheet is laminated over the electrode of second polarity with a first sealing sheet and a second sealing sheet peeling off,
lamination of the electrode of second polarity and the battery cell sheet, in which the first sealing sheet and the second sealing sheet are peeled off, is repeated,
a sealing sheet on at least a lower laminated surface side in an uppermost battery cell sheet is peeled off,
tab portions of electrode current collectors of first polarity in the laminated battery cell sheets are welded,
tab portions of electrode current collectors of second polarity in the laminated electrodes of second polarity are welded, and
the laminated battery cell sheets and electrodes of second polarity are stored in an outer package body with tab portions of the first polarity and tab portions of the second polarity protruding out of the outer package body.

12. The secondary battery according to claim 11, wherein a concentration of propylene carbonate is 30.7 wt % or more based on a total weight of entire liquid components contained in the electrode mixture layers of the laminated battery cell sheets and electrodes of second polarity.

13. The secondary battery according to claim 11, wherein a concentration of vinylene carbonate is in a range of 2.19 wt % to 4.00 wt % based on a total weight of entire liquid components contained in the electrode mixture layers of the laminated battery cell sheets and electrodes of second polarity.

14. (canceled)

15. (canceled)
